(19) United States
(12) Patent Application Publication
(10) Pub. No.: US 2008/0228549 A1
(43) Pub. Date: Sep. 18, 2008

(54) PERFORMANCE EVALUATION SYSTEMS AND METHODS

(76) Inventor: Michael J. Harrison, Austin, TX (US)

Correspondence Address: COHEN & GRIGSBY, P.C., 11 STANWIX STREET, 15TH FLOOR, PITTSBURGH, PA, 15222, US

(21) Appl. No.: 11/685,970

(22) Filed: Mar. 14, 2007

(51) Int. Cl. G06Q 10/00

(52) U.S. Cl. 705/9; 705/11

(57) ABSTRACT

A performance evaluation system. The system includes a performance evaluation module configured to enable employee performance reviews based on completion of a plurality of tasks and a plurality of skills required to complete the tasks for each of a plurality of projects on which an employee is staffed, wherein the performance evaluation module returns an employee performance score for the employee in relation to other employees at comparable job levels as the employee. The system also includes a project staffing module configured to enable a user to staff a project by selecting at least one candidate employee based on a skill level proficiency rating in a desired skill and a length of time for which the candidate employee has utilized the desired skill. The system further includes a skills management module configured to enable a user to search a database for persons who have a specified skill and an external contacts module configured to enable a user to search for contact information in the database.

### BACKGROUND

Performance evaluation is an important organizational component that impacts many aspects of management and its workforce (e.g., pay, promotion, accountability, retention, training, etc.). Performance evaluation is a core component of human resources management because it satisfies both organizational and individual needs. As organizations and corporate culture continue to change and expand, performance evaluation systems have not adapted to meet such changes and expansion.

There are many types of performance evaluation systems, each having the goal of producing a bottom-line report card on each employee in an organization. However, prior performance evaluation systems have not fared well because, for example, measurement tools are not clear, responsive, reliable or defendable. Also, managers and other supervisory personnel contribute to the failure of such systems because they want to be liked by employees or “play it safe” to avoid contentious issues and grievances. These factors often cause managers to over-inflate performance evaluations and create meaningless results. Also, prior systems have the disadvantage that one person judges another, so such systems do not satisfy everyone.

### SUMMARY

In various embodiments, the present invention is directed to a performance evaluation system. The system includes a performance evaluation module configured to enable employee performance reviews based on completion of a plurality of tasks and a plurality of skills required to complete the tasks for each of a plurality of projects on which an employee is staffed, wherein the performance evaluation module returns an employee performance score for the employee in relation to other employees at comparable job levels as the employee. The system also includes a project staffing module configured to enable a user to staff a project by selecting at least one candidate employee based on a skill level proficiency rating in a desired skill and a length of time for which the candidate employee has utilized the desired skill. The system further includes a skills management module configured to enable a user to search a database for persons who have a specified skill and an external contacts module configured to enable a user to search for contact information in the database.

In various embodiments, the present invention is directed to a computer-assisted method of evaluating a performance of a person. The method includes presenting a survey to a plurality of employees associated with a unit, wherein the survey includes questions relating to a plurality of skills related to a project being performed by the unit and calculating a first score of the performance of the person based on a plurality of answers given by the plurality of employees to the questions. The method also includes reviewing, by a supervisor, the person and calculating a final score of the performance of the person based on the first score of the performance of the person and the reviewing, by the supervisor, the person.

In various embodiments, the present invention is directed to a system. The system includes means for presenting a survey to a plurality of employees associated with a unit, wherein the survey includes questions relating to a plurality of skills related to a project being performed by the unit and means for calculating a first score of a performance of a person based on a plurality of answers given by the plurality of employees to the questions. The system also includes means for reviewing, by a supervisor, the person and means for calculating a final score of the performance of the person based on the first score of the performance of the person and the reviewing, by the supervisor, the person.

In various embodiments, the present invention is directed to a computer-readable medium having stored thereon instructions which, when executed by a processor, cause the processor to:

present a survey to a plurality of employees associated with a unit, wherein the survey includes questions relating to a plurality of skills related to a project being performed by the unit;

calculate a first score of a performance of a person based on a plurality of answers given by the plurality of employees to the questions;

enable review, by a supervisor, the person; and

calculate a final score of the performance of the person based on the first score of the performance of the person and the reviewing, by the supervisor, the person.

Those and other details, objects, and advantages of the present invention will become better understood or apparent from the following description and drawings showing embodiments thereof.

### BRIEF DESCRIPTION OF THE DRAWINGS

The accompanying drawings illustrate examples of embodiments of the invention. In such drawings:

FIG. 1 illustrates an embodiment of a performance evaluation and staffing system;

FIG. 2 illustrates an embodiment of a process for evaluating employees;

FIG. 3 illustrates an embodiment of a process for staffing a project;

FIG. 4 illustrates an embodiment of a process for managing employee skills; and

FIGS. 5-29 illustrate embodiments of screenshots of an implementation of an example performance evaluation and staffing system.

### DESCRIPTION

As used herein, the term “employee” means any person who is affiliated or associated with an organization that utilizes the systems and methods described herein. As used herein, the term “organization” means any entity, individual, etc. that utilizes, administers, etc. the systems and methods described herein. As used herein, the term “unit” means any organization or portion thereof such as, for example, a department, a division, a team, a group, a project, etc.

Various embodiments of the present invention calculate a network-based measure of performance evaluation. Various embodiments of the present invention allow for measuring employee learning and job performance. Various embodiments allow an organization to: (1) develop and integrate learning and performance measures to analyze and report results; (2) link performance metrics to broader business goals while tempering the metrics to an employee's role and level in the organization; and (3) develop performance metrics linked to job-related tangible and intangible elements. Embodiments facilitate acceptance by all levels of management and employees in an organization and allow organizations to establish performance evaluation processes that support the achievement of organizational outcomes.

Various embodiments of the present invention facilitate project staffing based on employee skills and facilitate matching employees with other employees who have similar skills. Various embodiments also facilitate collection by employees of contact information that is external to the organization for which the employees are associated.

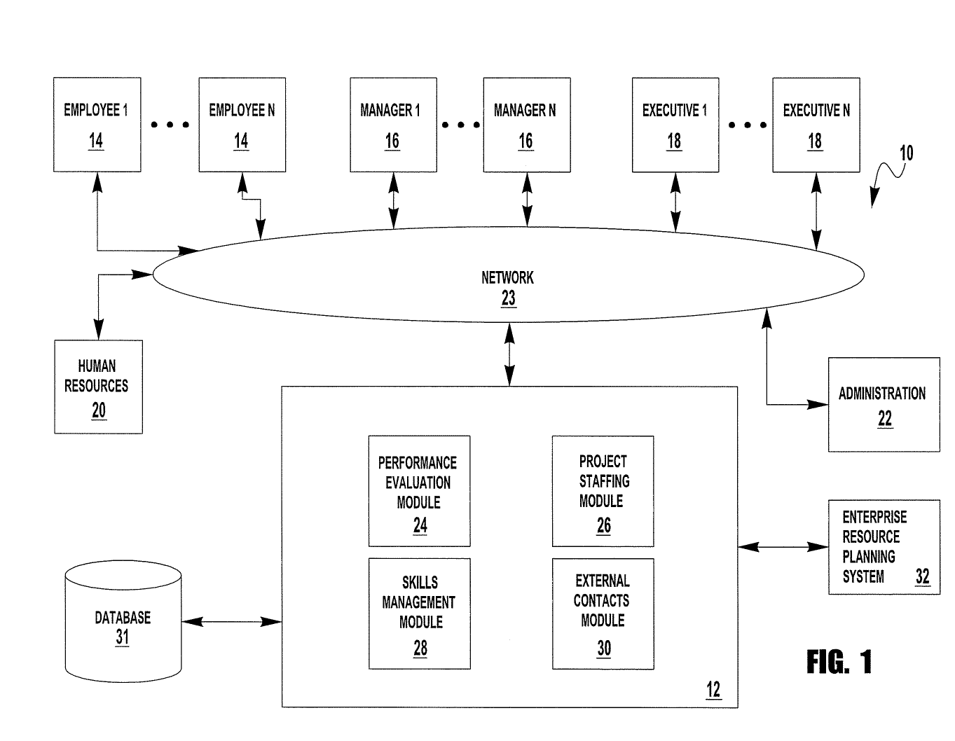

FIG. 1 illustrates an embodiment of a performance evaluation and staffing system 10. The system 10 includes an evaluation/staffing engine 12. The system 10 is a role-based system with different features and functionality for each role. The roles are defined according to the users of the system 10, which are shown in FIG. 1 as employees 14, managers 16, executives 18, human resources personnel 20 and administrators 22. The administrators 22 and the human resources personnel 20 have the ability to grant permissions to the various users 14, 16, 18, 20 and 22. A particular user may have assigned to them one or more of the roles performed by the users 14, 16, 18, 20 and 22. For example, a user in a human resources department may be an employee 14, a manager 16 and a human resources personnel 20 and would thus have access privileges to the engine 12 accordingly. The various users 14, 16, 18, 20 and 22 are in communication with the evaluation/staffing engine 12 via, for example, a network 23. The network 23 may be, for example, a local area network (LAN), a wide area network (WAN), an intranet, the Internet, or any other type of suitable network.

Each of the employees 14 is automatically given with the role of employee upon, for example, joining the organization which employs or utilizes the system 10. The employees 14 may create all employee performance related data in the system 10. In various embodiments, skills of the employees 14 are evaluated using a performance evaluation module 24 of the evaluation/staffing engine 12 as the employees 14 perform their job responsibilities in their unit and project-based work. In various embodiments, each skill relating to a unit or project is conceptualized as a knowledge network (i.e., who knows what and in what context). Employees 14 are required to complete unit and/or project-based surveys, which serve as the primary data used to generate employee performance scores. In calculating employee performance scores, each employee 14 specifies other employee(s) 14 they believe serve as resources for the skill at interest on a given unit or project. This process may remove the inherent bias in many employee performance systems by giving employees 14 an equal voice in their opinion of who is doing what well.

Each employee 14 is given a specific job level and employees 14 are evaluated only in relation to other employees 14 within their respective job levels. Human resource personnel 20 have the ability to specify one or more management reviews per unit and managers 16 have the ability to specify one or more management reviews per project. These reviews contain performance areas and objectives on which managers 16 rate their employees. Various embodiments of the performance evaluation module 24 use a series of social network-based algorithms and averages to create employee performance scores on, for example, a 100 point scale.

The managers 16 have the ability to create and staff projects using a project staffing module 26 of the evaluation/staffing engine 12. The managers 16 may specify a set of skills required to complete a project and the employees 14 are evaluated on those skills. Once the managers 16 have specified a set of skills, the project staffing module 26 finds the employees 14 with the best scores in those skills as well as the employees 14 that have utilized those skills for the longest period of time. In various embodiments, it is possible for one of the managers 16 to staff only the employees 14 that have worked with one another and have a minimum level of trust in each other as specified by the employees 14 themselves.

In various embodiments, the managers 16 have the ability to visualize the communication, trust or knowledge networks of the organization on the relevant projects. In various embodiments, the managers 16 may also require reviews for the relevant projects, where each review contains, for example, one or more performance areas in which employees 14 are evaluated on performance objectives. The executives 18 may visually analyze the organization which employs or utilizes the system 10. The executives 18 may visualize the flow of information, transfer of knowledge or the information structures in which their organization operates.

The human resources personnel 20 have the ability to create one or more review periods in which the employees 14 are evaluated. For example, the human resources personnel 20 may want the employees 14 in an accounting department to be evaluated semi-annually in the United States but quarterly in Germany. In various embodiments, the human resources personnel 20 make the final evaluation on the performance areas and objectives for unit and project driven reviews. The administrators 22 have the ability to manage system 10 connectivity, parameters and user accounts and access privileges.

A skills management module 28 of the evaluation/staffing engine 12 facilitates management of skill levels for all employees 14. The module 28 combines the social networks of the organization with employee skill searching to provide the employees 14 the ability to search for others with skills that they need for a particular project. In various embodiments, the module 28, in response to a search by one of the users 14, 16, 18, 20 and 22, returns a rank-ordered listing of the employees 14 with the highest levels, within and outside the user's self-identified social network, of skills input by the user.

An external contacts module 30 of the evaluation/staffing engine 12 allows the employees 14 to enter contact information about people that are, for example, external to the organization which employs or utilizes the system 10. The employees 14 can search the contacts of other employees 14 to facilitate, for example, sales and marketing. The employee 14 who enters information about a particular contact has control over whether other employees 14 can view or edit the contact information.

The system 10 also includes a database 31 that is used by the engine 12 to store, for example, data collected by and relating to the operation of the system 10 and the users 14, 16, 18, 20 and 22. The data may assist the engine 12 in creating units in which the users 14, 16, 18, 20 and 22 are placed. The evaluation/staffing engine 12 may be in communication with an enterprise resource planning (ERP) system 32, such as those marketed by Oracle, SAP, Baan and JD Edwards. The ERP system 32 may communicate data, such as data associated with users 14, 16, 18, 20 and 22 to the engine 12. The data may be communicated periodically (e.g., nightly) or whenever necessary or desirable for operation of the system 10. The engine 12 may be in communication with the system 32 via, for example, a dedicated network, the network 23, the Internet, etc. Data may be obtained from the system 32 directly or read from a file (e.g., an XML or flat text file) to which data from the system 32 is exported.

In various embodiments, the engine 12 may be implemented in computer software. By way of example, the engine 12 may be a web-based enterprise application and its various modules 24, 26, 28 and 30 may be implemented in, for example, the Ruby on Rails web application framework.

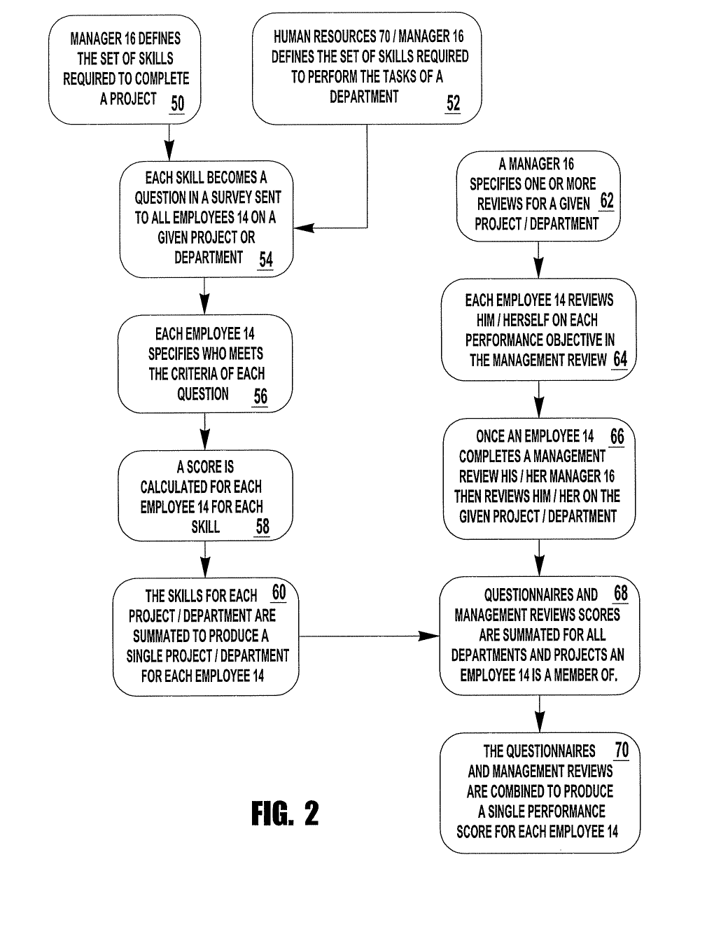

FIG. 2 illustrates an embodiment of a process for evaluating employees 14. The process illustrated in FIG. 2 may be performed by the performance evaluation module 24 of FIG. 1.

Embodiments of the present invention allow for the evaluation of employees 14 in the context in which they are working. For example, if an employee 14 works on several teams during a given evaluation period the employee 14 should not be evaluated once across all teams but should rather be evaluated based on the goals set forth by each team and the contribution of the employee 14 to the team and goals. Thus, embodiments of the present invention provide for the evaluation of employees 14 in the contexts in which they work and the goals associated therewith, and thus employee performance can be assessed empirically in a directly comparable manner.

Embodiments of the present invention provide for employee ratings that are determined in whole by two components: resource utilization scores and goals ratings, thus providing an accurate assessment of an employee's 14 performance that is directly comparable to that of all other employees 14. In various embodiments, two assumptions concerning an organization may be made. First, employees 14 do not work in isolation but rather work in units, such as departments, teams, groups, or projects, with specific goals and defined responsibilities. Second, organizations are hierarchical in which each employee 14 has one or more supervisors.

Various embodiments of the present invention allow for employee ratings that are based on how well the employee 14 has utilized their skills to meet the goals of the unit. For example, if employee Bob is an expert in databases but does not contribute to solving many of the database problems on a given unit, then his contribution to solving database problems on the unit is non-existent. In contrast, employee Jane, whose expertise is less than that of Bob, has actually solved most of the database problems and has become the source of database information for employees within the unit. In this scenario employee Jane should receive the credit for her database work on the unit, not her overall skill level.

In various embodiments of the present invention, each unit has an established set of goals and skills, or tasks, necessary to complete the goals. Next each employee 14 on a given unit rates all others on the set of skills. At step 50 in FIG. 2, the managers 16 define the set of skills required to complete a project. At step 52, the human resources personnel 20 and the managers 16 define the set of skills required to perform the tasks of a unit. Skills may be, for example, tangible or intangible, but, as described herein, each employee 14 specifies, on a given unit, who is being utilized in terms of the skills. At step 54, surveys are used to collect data and are distributed at specified intervals to all employees 14 on a unit. Surveys may be distributed periodically such as, for example, daily, weekly, etc. Each skill becomes a question in a survey that is sent to all employees 14 on a given project or in a given unit. An employee 14 may simultaneously be a member of one or more units. For example, if the skills required to complete the goals of a unit are A, B and C then each employee 14 is asked to complete a survey asking questions such as, for example, “Who do you consider a resource on the department/project/group for skill A?” Each employee 14 specifies, at step 56, the employees 14 that meet the criteria of each question. In various embodiments, answers to the survey questions are kept confidential. At step 58 the centrality (a measure of importance relative to others in the group) is calculated for each employee 14 on each skill and at step 60 they are summated to achieve a resource utilization score for each employee 14.

At step 62, a manager 16 specifies one or more reviews for a given project or unit. At step 64 each employee 14 rates themself for the skills required for the tasks in which they are assigned in a given review period. It may be assumed that management reviews are best evaluated by supervisors with whom the employees 14 have had direct contact. At step 66 the manager 16 reviews the employee 14.

In various embodiments, steps 50 to 66 are repeated for each unit of which an employee 14 is a member. At step 68 questionnaire scores and management review scores are summated for all units and projects which pertain to each employee 14. Scores may be normalized at both the skill and unit levels so that all employees 14 receive an equitable share of credit, independent of the magnitude, for any given skill. This process is similar to the concept of “curving” with respect to classroom grades. In grade curving if, for example, the average student grade in a course was 50 then the teacher could curve the grades, making the highest grade a 100 and the remaining grades to be divided by that highest grade. At step 70 the questionnaire scores and management review scores are combined to produce a single performance score for each employee 14.

An embodiment of a process for calculating employee performance is illustrated hereinbelow. The process is divided into two sections—resource utilization (steps 50-67) and management reviews (steps 62-66).

Resource Utilization Calculation:
1. Calculate the indegree centrality for each employee 14 on each skill within a unit:

$$\frac{indegree for node i}{degree for all nodes in unit u} \qquad ( 1 )$$

The calculation (1) is repeated for all i nodes on u units.
2. Normalize skill scores:

$$\frac{score for node i on skill m}{maximum score on skill m for unit u} \qquad ( 2 )$$

The calculation (2) is repeated for all i nodes on u units.
3. Sum skill scores for each node in unit u and divide by the number of skills.
4. Normalize unit scores:

$$\frac{skill score for node i}{maximum score for skill m on unit u} \qquad ( 3 )$$

The calculation (3) is repeated for all in skills on u units.
5. Calculate average resource utilization scores by summing the average skills scores for
   each unit and dividing by the number of units.

Management Review Calculation:
6. Calculate the average management review score per reviewer:

$$\frac{\sum goals scores}{number of goals} \qquad ( 4 )$$

7. Sum the average management review scores per reviewer and divide by the number of reviewers. The calculation is repeated for all i nodes and r reviews.

8. α(average resource utilization score)×β(average goal score) (5)

where α and β must sum to 1.
9. Normalize by job level:

$$\frac{score for node i}{maximum score for node {i}^{′} s job level} \qquad ( 6 )$$

The calculation (6) is repeated for all i nodes.

Employees 14 are normalized at the job level so that employee scores are relative to other employees 14 at their job level. Normalizing ensures that employees 14 at different hierarchical levels still produce comparable scores. For example, because resource utilization per unit is calculated, it is likely that lower level employees 14 will have more of the technical and task-related skills than managers 16 on the unit. This is so because their job functions and responsibilities serve different purposes. Often it is not the job of a manager 16 to actually perform work but rather delegate the work and assure a quality product. Thus, it may not be fair to compare lower level employee resource utilization ratings to those of managers 16 because they will almost always be higher. Embodiments of the processes herein account for the variation among job levels while still producing comparable performance evaluation scores between employees 14 of different job levels. A measure indicating employee performance regardless of job level, unit participation or skills may be produced.

The combination of the aforementioned aspects of employee scores creates comparable, defendable ratings among employees 14 because each employee's 14 performance score is precisely a measure of that employee's 14 performance in a given period. Based on performance scores, employers may select certain employees 14 for promotion and others for termination. In a hierarchical organization, higher position leads to higher status.

In various embodiments employees 14 can be assessed by the quality of their work irrespective of their job level or status. Various embodiments make three assumptions with respect to quality and status in organizations. First, it is assumed that employees 14 in a hierarchical organization with higher performance ratings are of higher quality. Second, it is assumed that employees 14 with higher quality are promoted. In the context of most organizations, promotion leads to higher status. Third, it is assumed that only quality employees 14 get promoted. If the assumptions hold true there is a strong link between quality and status in terms of performance evaluation. Also, there is a causal relationship between quality and status. In this context an employee 14 cannot achieve status without quality.

When employees 14 rate other employees 14 on units in which they participate, context is added to performance evaluation and members' experiences, within units, may be expressed. In various embodiments, by allowing each member of a unit to evaluate all other members, one member's ratings cannot significantly impact, whether negatively or positively, the overall rating. The centrality measure of resource utilization adds accountability to the process. If an employee 14 is not contributing, the centrality-based rating will highlight this fact.

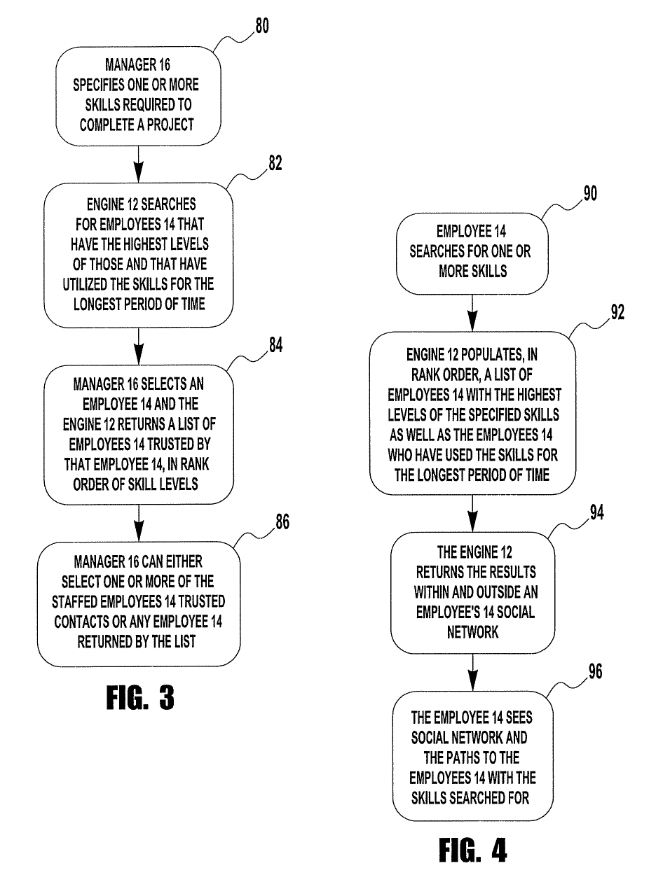

FIG. 3 illustrates an embodiment of a process for staffing a project. The process illustrated in FIG. 3 may be performed by the project staffing module 26 of FIG. 1. At step 80 a manager 16 specifies one or more skills that are required to complete a particular project. At step 82 the evaluation/staffing engine 12 searches the database 31 for employees 14 that have the highest levels of skills specified in step 80 and have also utilized the specified skills for the longest period of time. At step 84 the manager 16 selects an employee 14 and a list of employees 14 that have been denoted as trusted by the selected employee 14 is returned in rank order of skill levels. The manager 16 may then, at step 86, choose the selected employee 14 or one of the trusted employees 14 to staff the project.

FIG. 4 illustrates an embodiment of a process for managing employee skills. The process illustrated in FIG. 4 may be performed by the skills management module 28 of FIG. 1. At step 90, an employee 14 searches for one or more skills. At step 92, a list of employees 14 is returned, in rank order according to the highest level of skill in the specified skills and according to employees 14 who have used the specified skills for the longest periods of time. At step 94, results are returned to the requesting employee 14. The results include individuals that have been specified by the requesting employee 14 as being inside that employee's 14 social network and as well as those individuals that are outside the employee's 14 social network. At step 96, the requesting employee 14 is shown a display of relationships (i.e., paths) between the requesting employee 14 and the employees 14 having the skills that the requesting employee 14 specified.

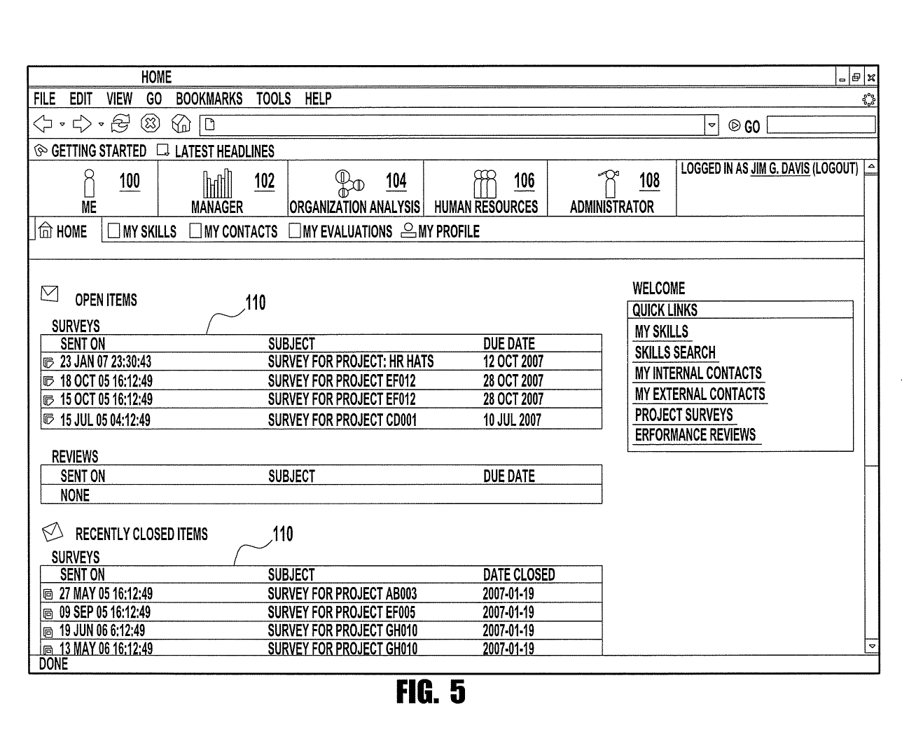

FIGS. 5-29 illustrate embodiments of screenshots of an implementation of an example performance evaluation and staffing system 10. FIG. 5 illustrates a screenshot when a “Me” tab 100 is selected by an employee 14. As shown in FIG. 5, the user who is logged in can access the “Me” tab 100 as well as a “Manager” tab 102, an “Organization Analysis” tab 104, a “Human Resources” tab 106 and an “Administrator” tab 108 because the user has access as an employee 14, a manager 16, an executive 18, a human resources personnel 20 and an administrator 22, respectively. FIG. 5 shows the status of various surveys 110 that were directed at the logged-in user.

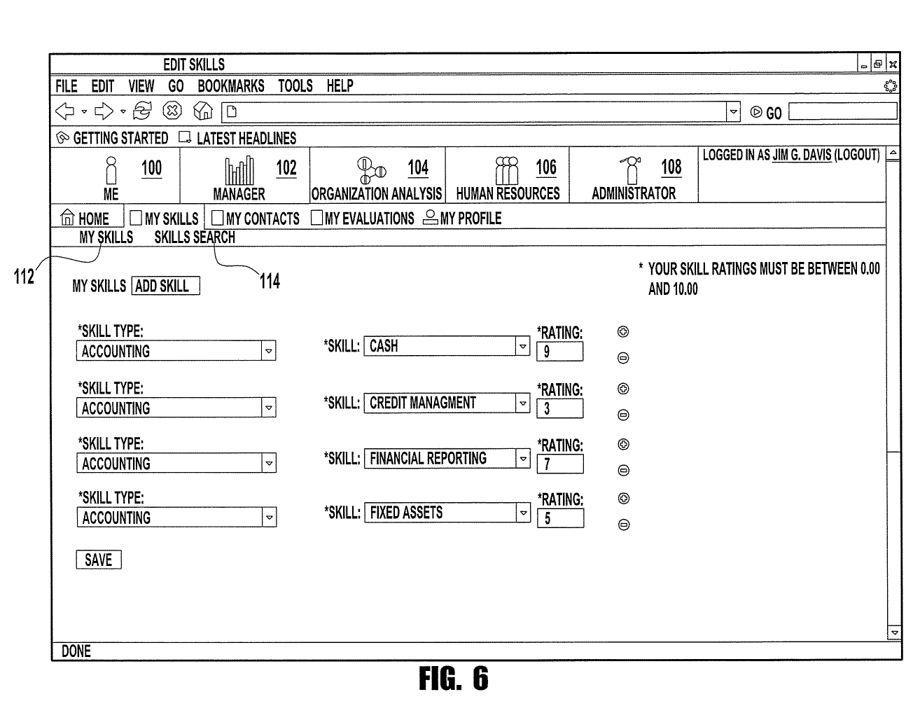

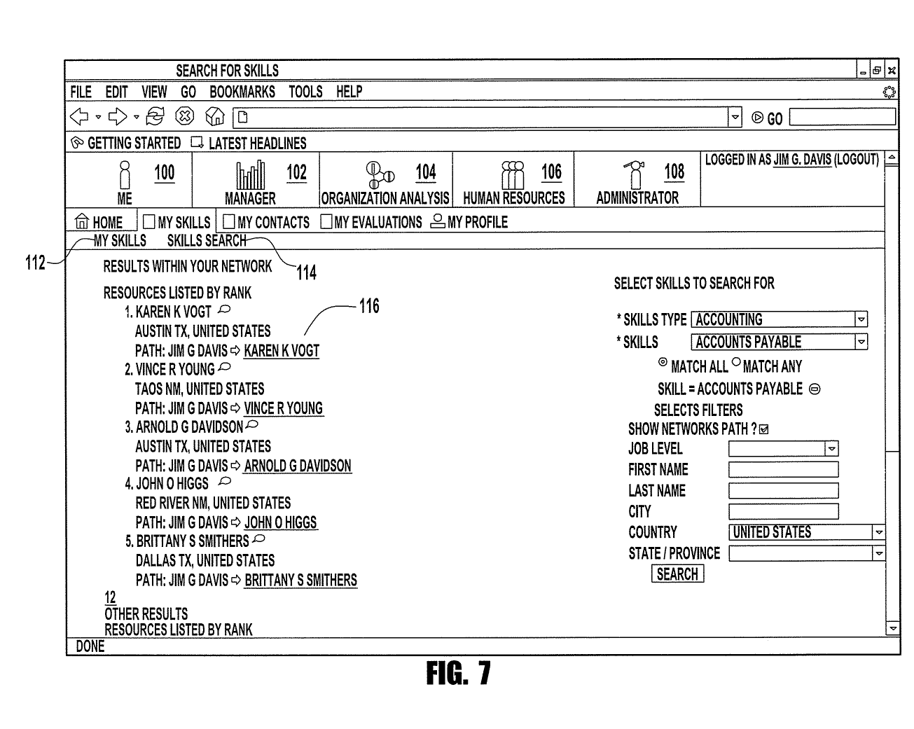

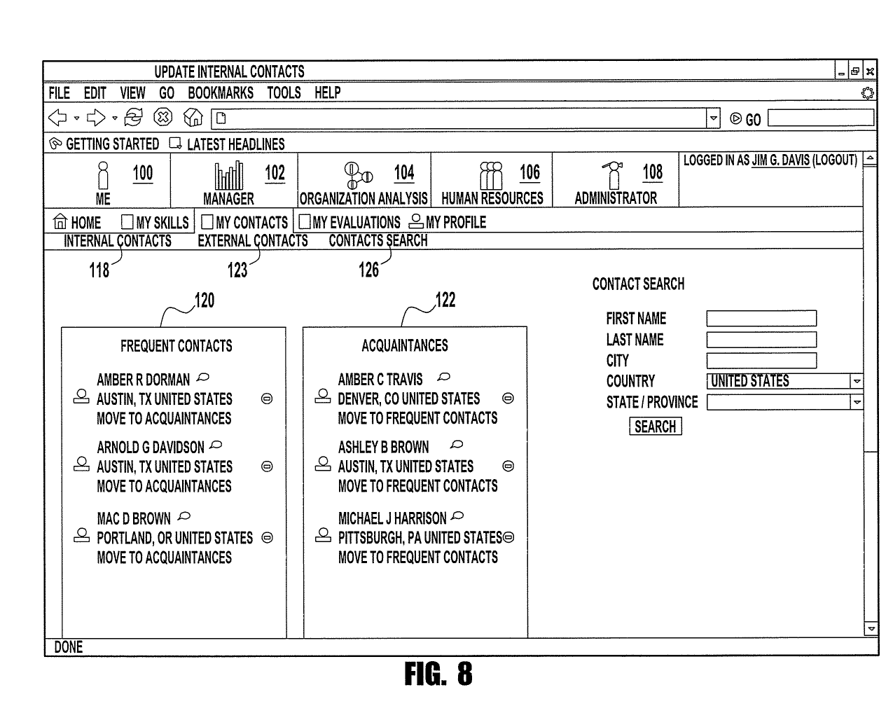

FIG. 6 illustrates a screenshot that results when the user selects a “My Skills” tab 112. The user's skills are displayed by type, skill and rating. FIG. 7 illustrates a screenshot that results when the user selects a “Skills Search” tab 114. In the illustrated example, the user has searched for employees 14 with a skill type of “Accounting” and a skill of “Accounts Payable.” A list 116 of employees 14 with that skill type and skill are illustrated in rank order.

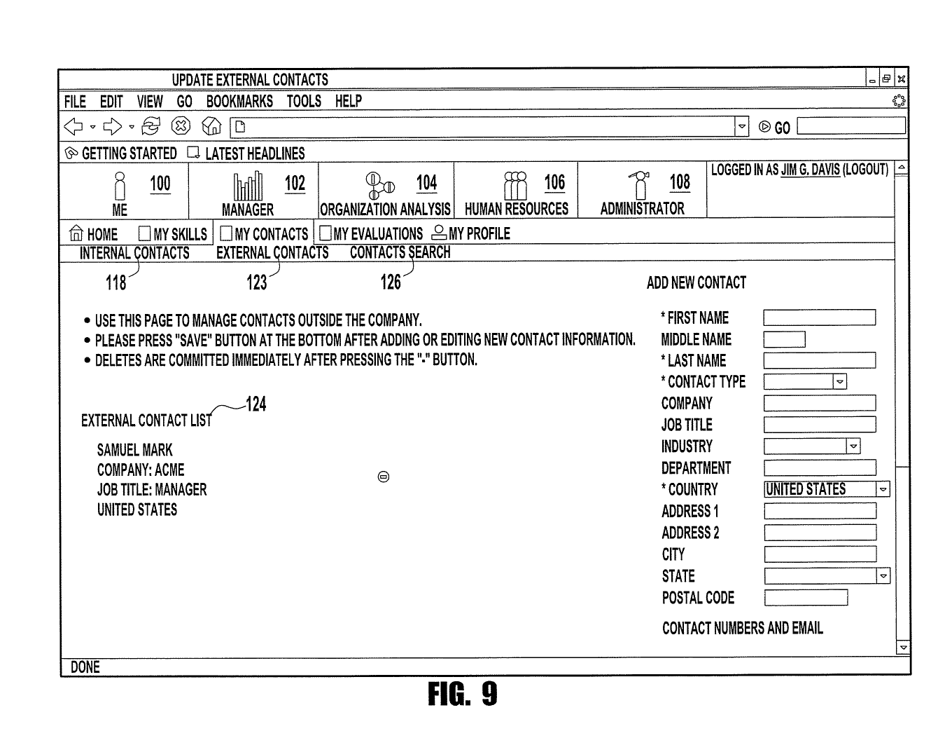

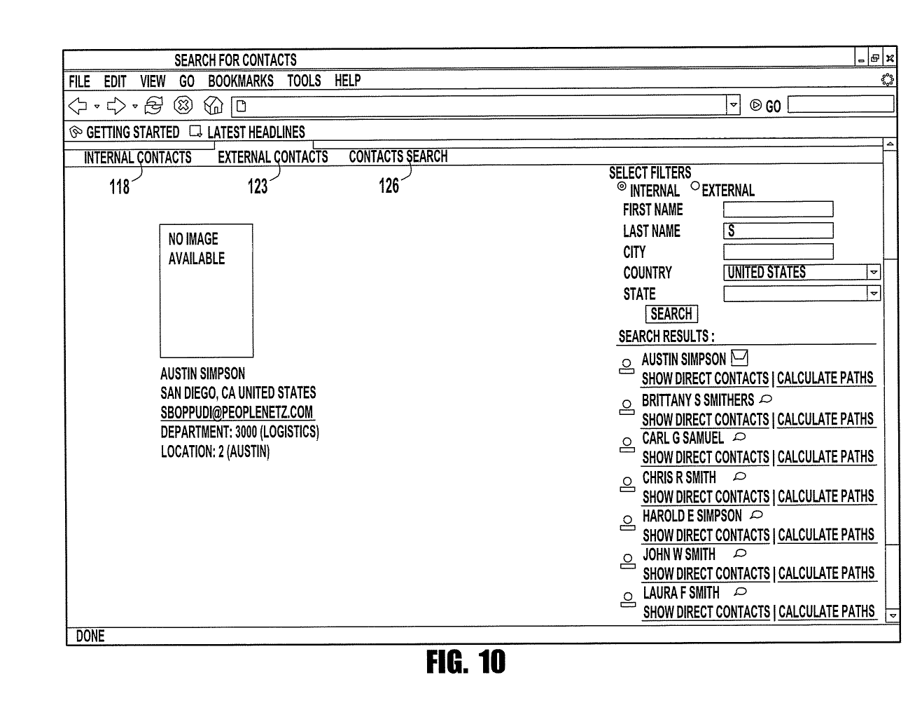

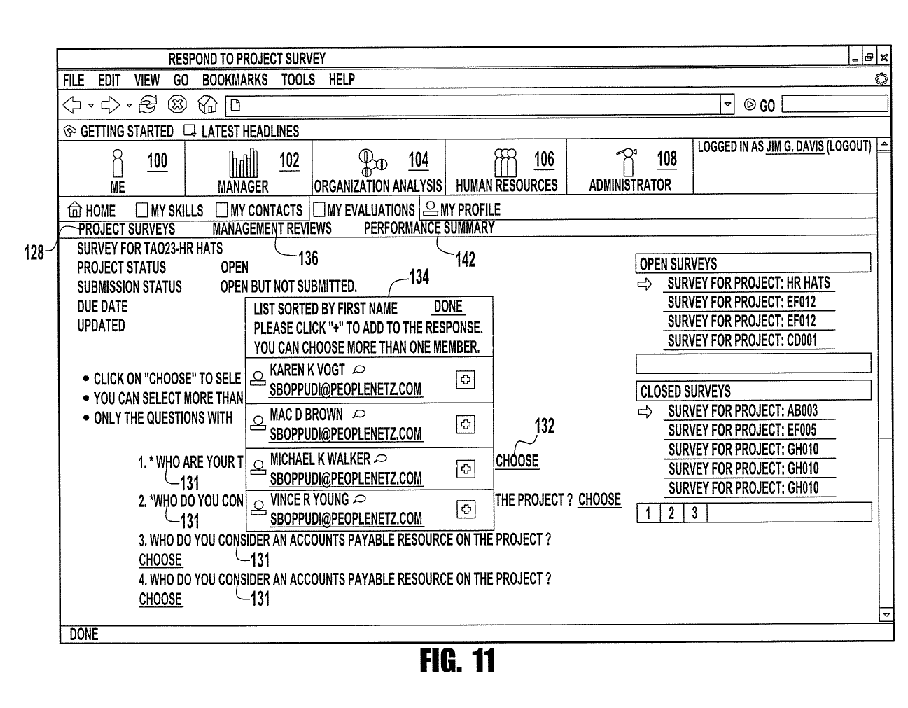

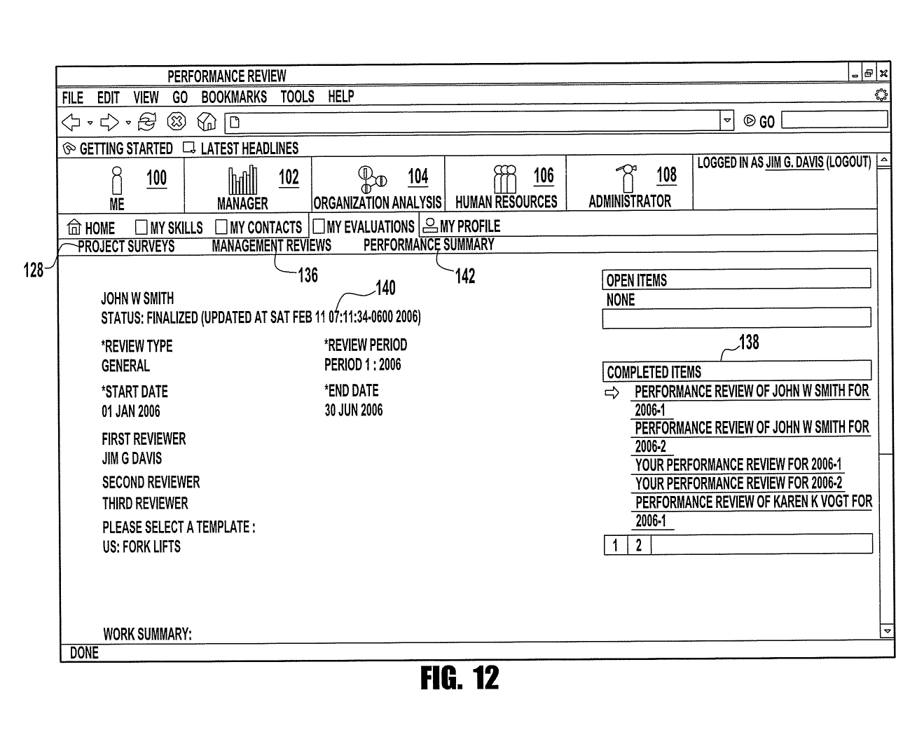

FIG. 8 illustrates a screenshot that results when the user selects an “Internal Contacts” tab 118. A list 120 of the user's frequent contacts and a list 122 of the user's acquaintances are returned. FIG. 9 illustrates a screenshot that results when the user selects an “External Contacts” tab 123. A list 124 of external contacts is returned. FIG. 10 illustrates a screenshot that results when the user selects a “Contacts Search” tab 126 and searches for contacts whose last names start with “S.” FIG. 11 illustrates a screenshot that results when the user selects a “Project Surveys” tab 128. In the example illustrated, the user has selected the project “HR Hats” and survey questions 130, 131 are returned. When the user selects a “Choose” selection 132, a list 134 of employees 14 who are staffed on the project “HR Hats” is returned. The user may then select from the list 134 to enter a response to the question 130.

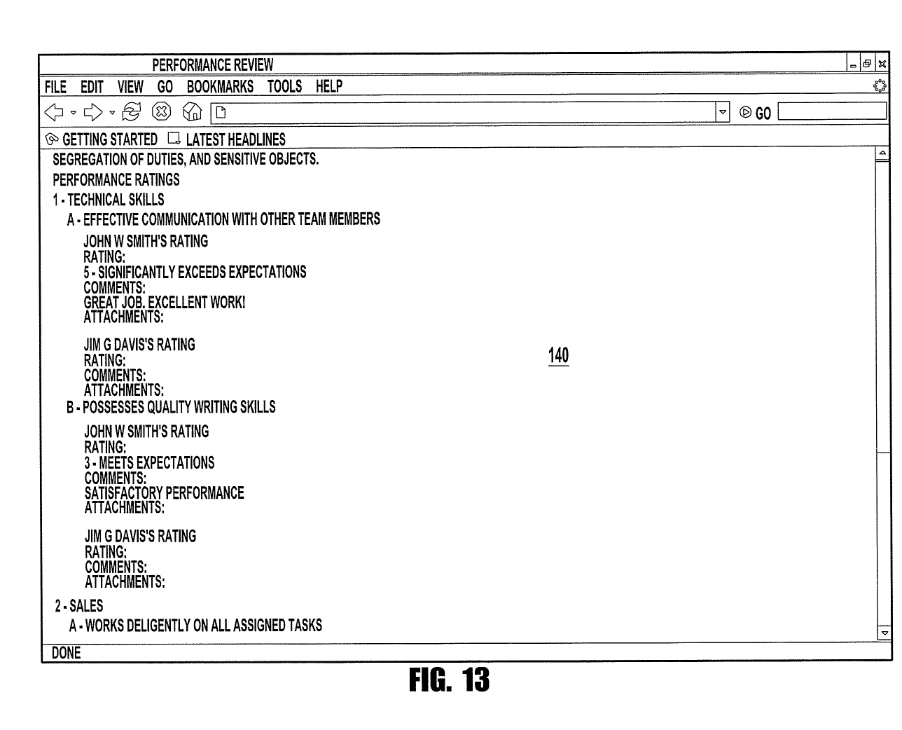

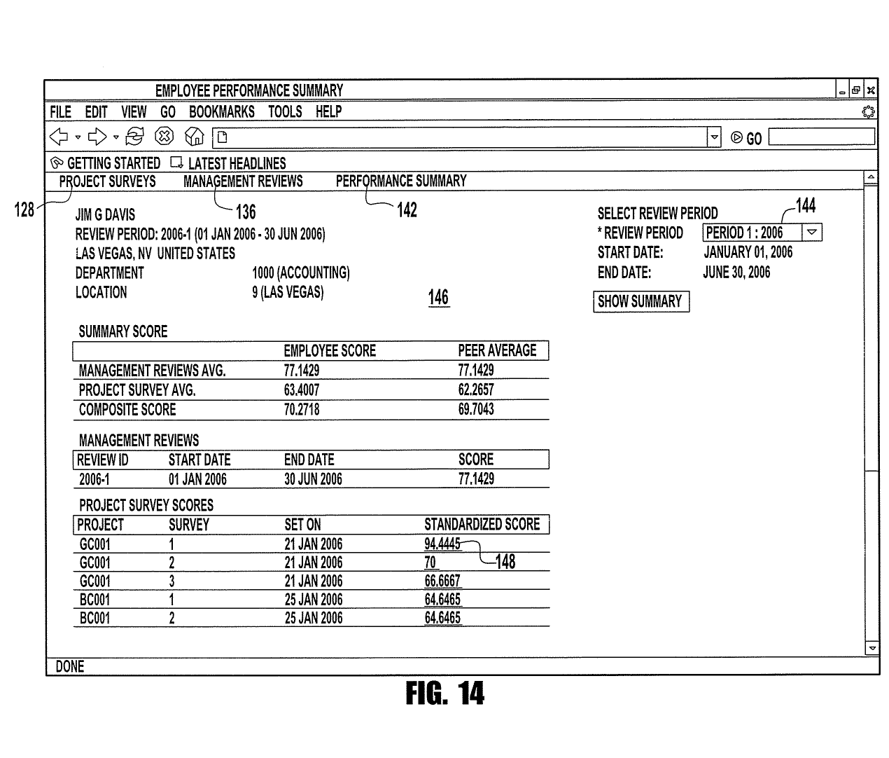

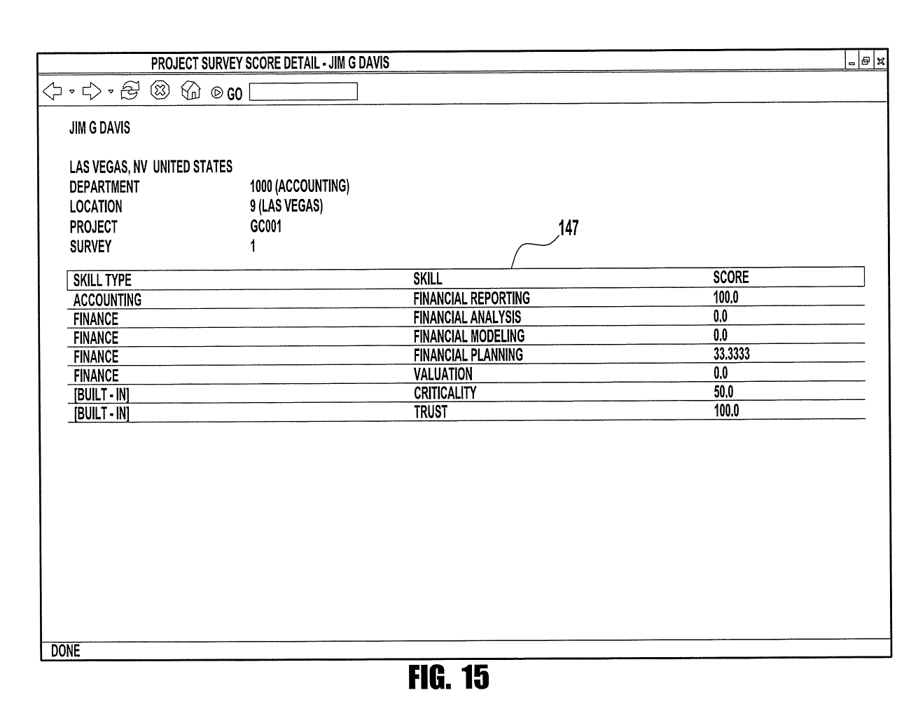

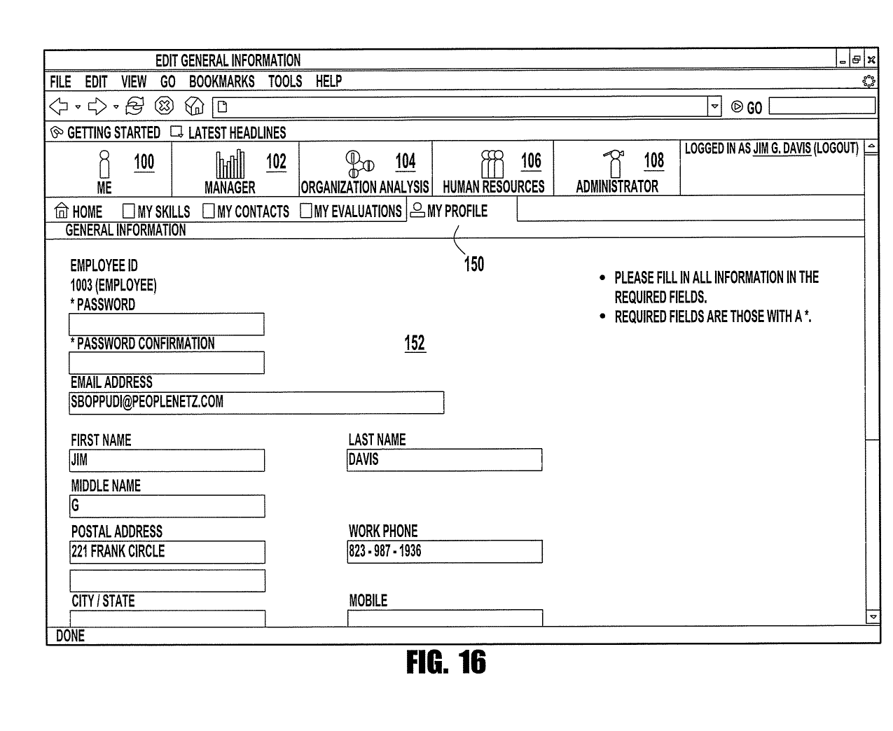

FIG. 12 illustrates a screenshot that results when the user selects a “Management Reviews” tab 136 and selects “Performance review of John W. Smith for 2006-1” in a “Completed Items” list 138. A review 140 is displayed for John W. Smith. As illustrated in FIG. 13, the review 140 provides performance ratings in various categories. FIG. 14 illustrates a screenshot that results when the user selects a “Performance Summary” tab 142 and selects “Period 1: 2006” in a review period dialogue box 144. A performance summary 146 is displayed for the user (in this case Jim G. Davis). FIG. 15 illustrates a screenshot of ratings 147 for the user when a standardized score 148 is selected in FIG. 14.

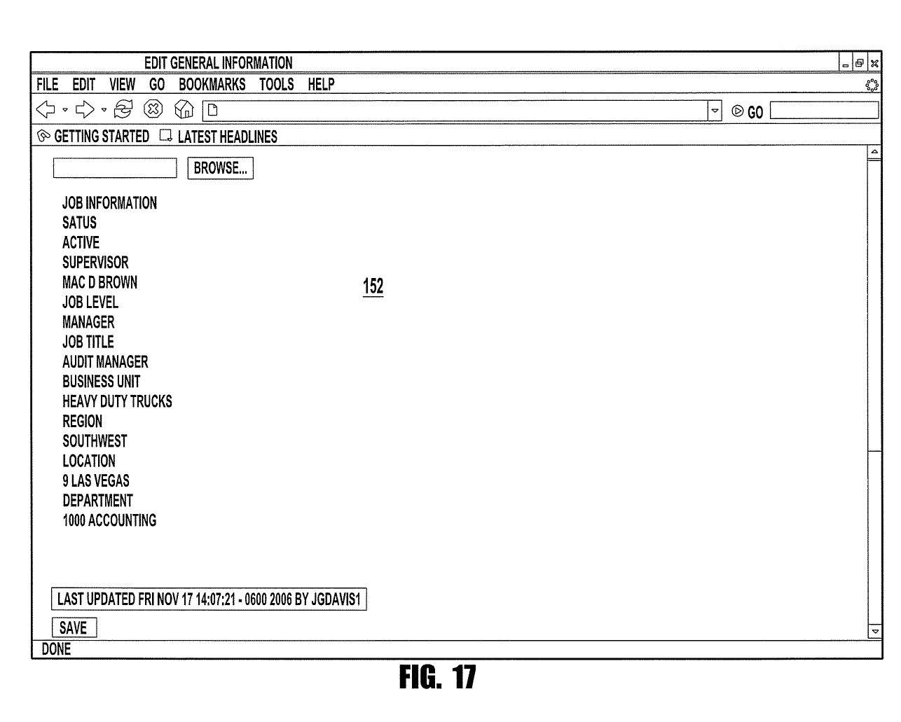

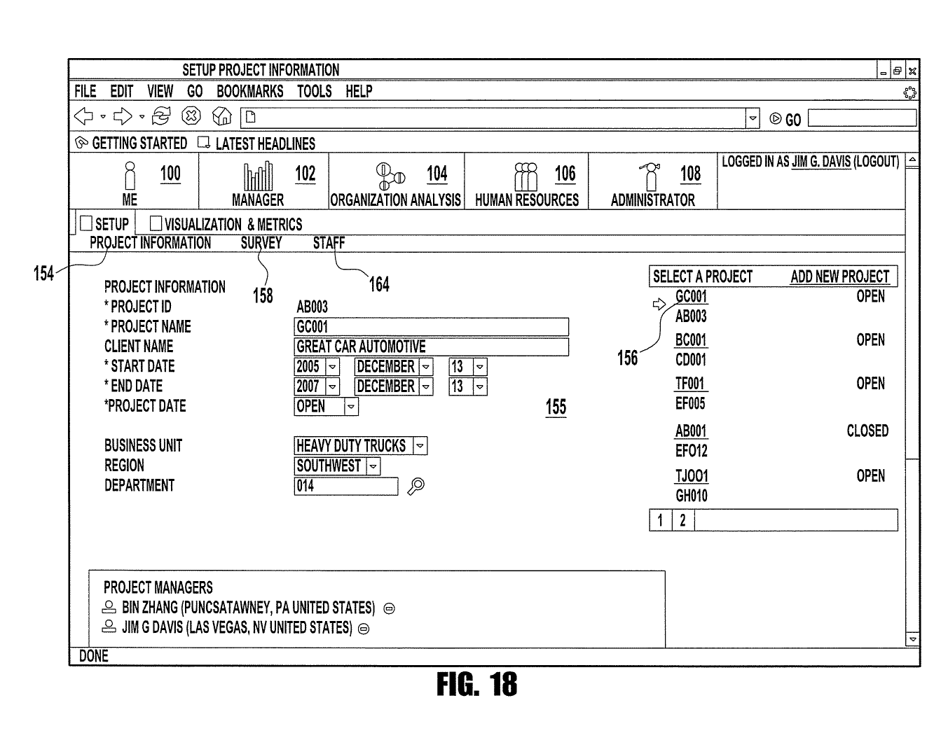

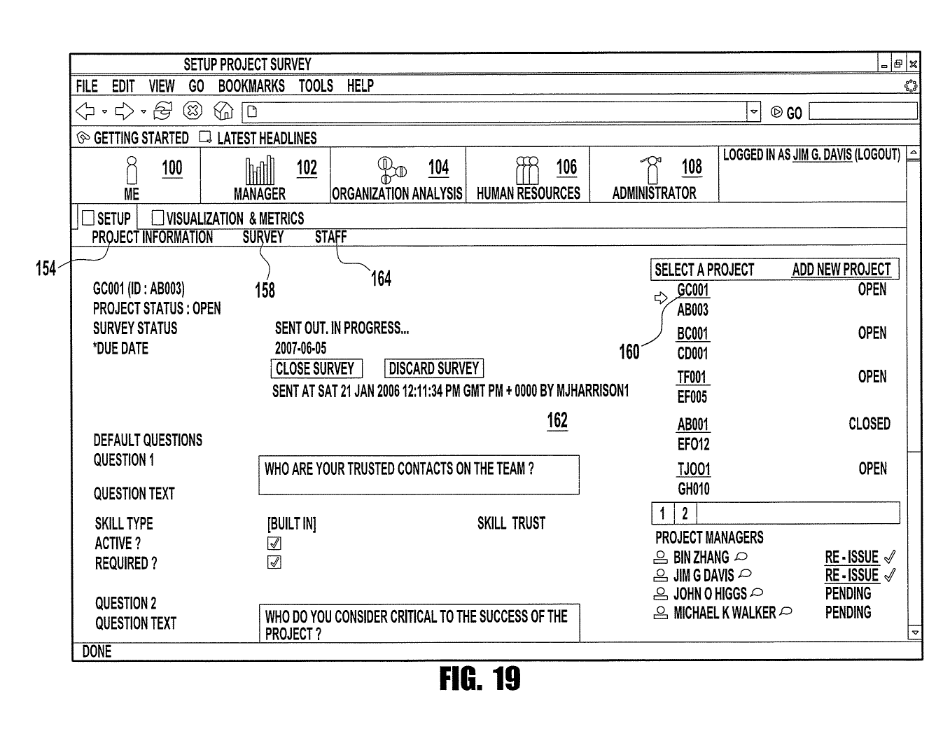

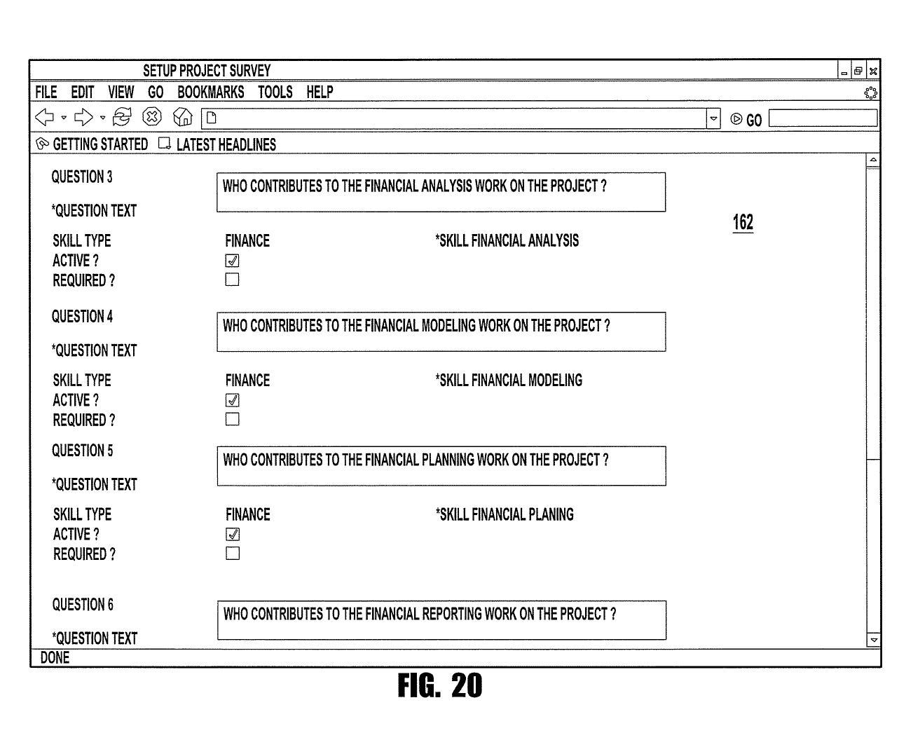

FIG. 16 illustrates a screenshot that results when the user selects a “My Profile” tab 150. A profile 152 is returned for the user and is shown continued in FIG. 17. Information for the profile 152 may be obtained from, for example, the enterprise resource planning system 32. FIG. 18 illustrates a screenshot that results when the user selects a “Project Information” tab 154 under the “Manager” tab 102. In FIG. 18, project information 155 is displayed after the user selects project “GC001” at 156. FIG. 19 is a screenshot that results when the user selects a “Survey” tab 158 and selects project “GC001” at 160. The contents of a survey 162, which is continued at FIG. 20, may be customized by the user.

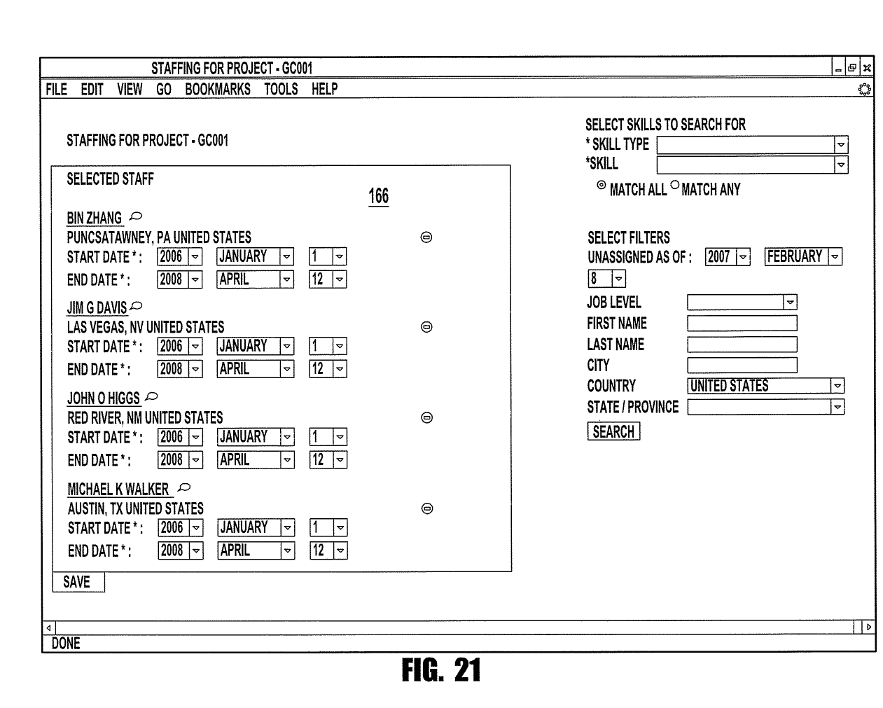

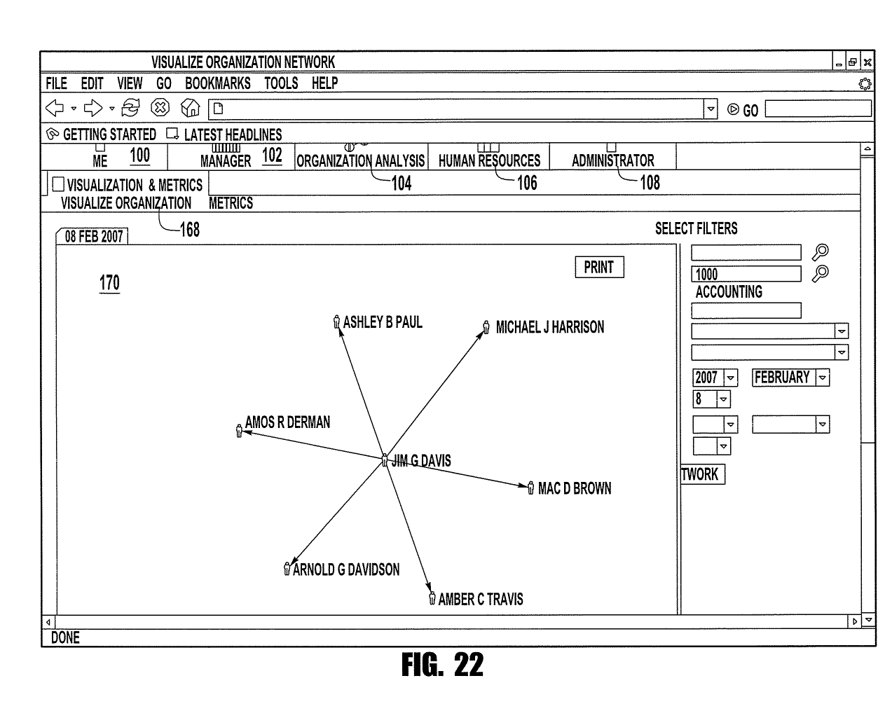

FIG. 21 illustrates a screenshot that results when the user selects a “Staff” tab 164. A list 166 of selected staff for a project (in this case project “GC001”) is returned. FIG. 22 illustrates a screenshot that results when the user selects a “Visualize Organization” tab 168 under the “Organization Analysis” tab 104. A diagram 170 shows the organization of an accounting department by showing arrows that connect the members of the department. In the example illustrated in FIG. 22, the arrows are unidirectional to indicate one-way communication but, in various embodiments, may be bidirectional to illustrate bidirectional communication between members of the department. Also, information may be obtained about each member by way of the user selecting the member for which information is desired.

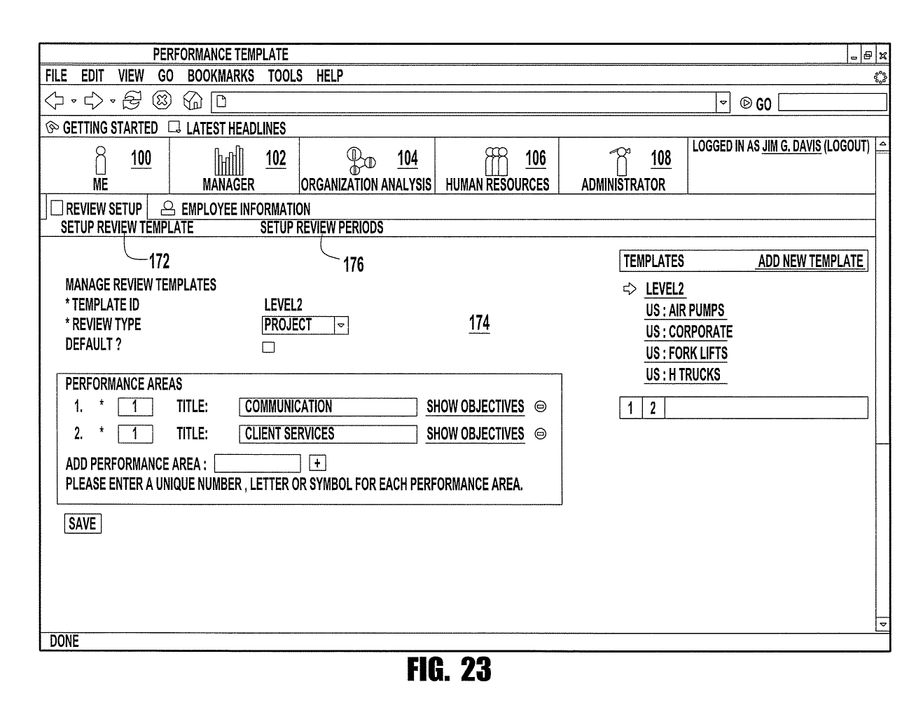

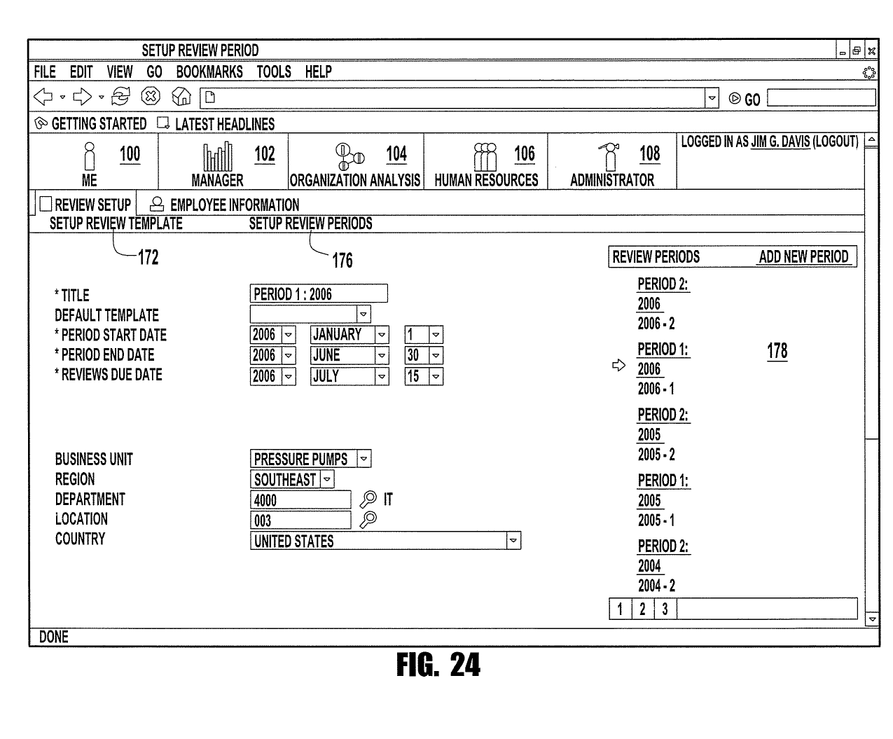

FIG. 23 illustrates a screenshot that results when the user selects a “Setup Review Template” tab 172 under the human resources tab 106. The user, acting as a human resources personnel 20, may manage the content of reviews using templates 174. FIG. 24 illustrates a screenshot that results when the user selects a “Setup Review Periods” tab 176. The user may specify start dates, end dates, etc. relating to various review periods that are listed at 178.

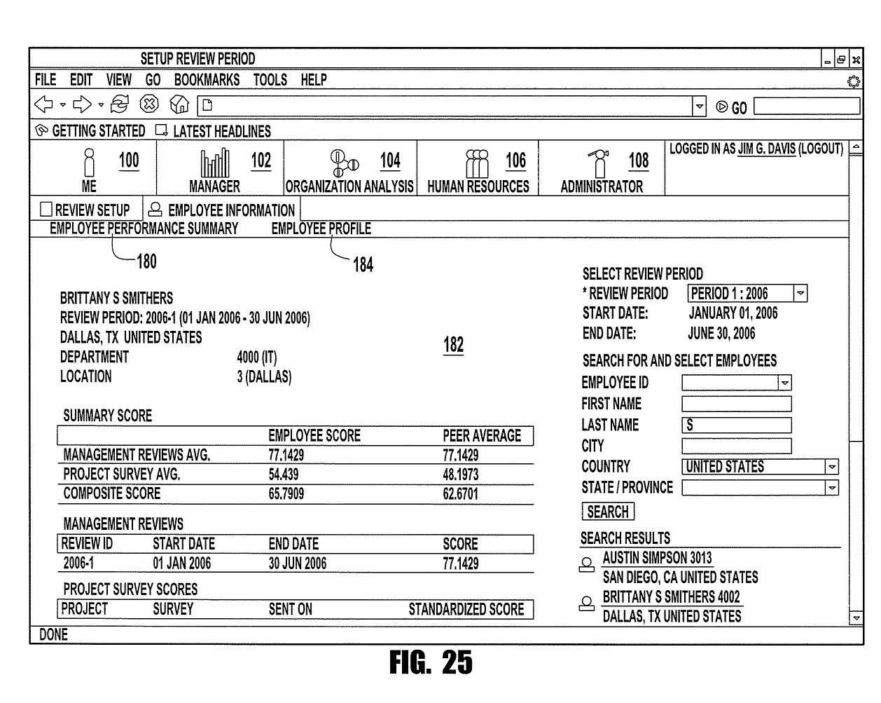

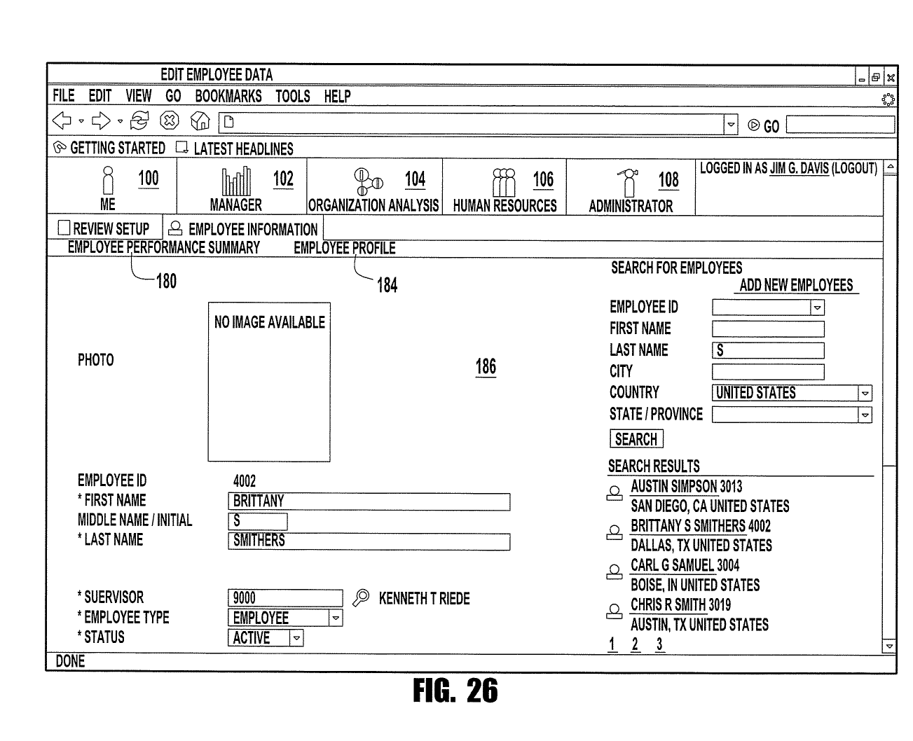

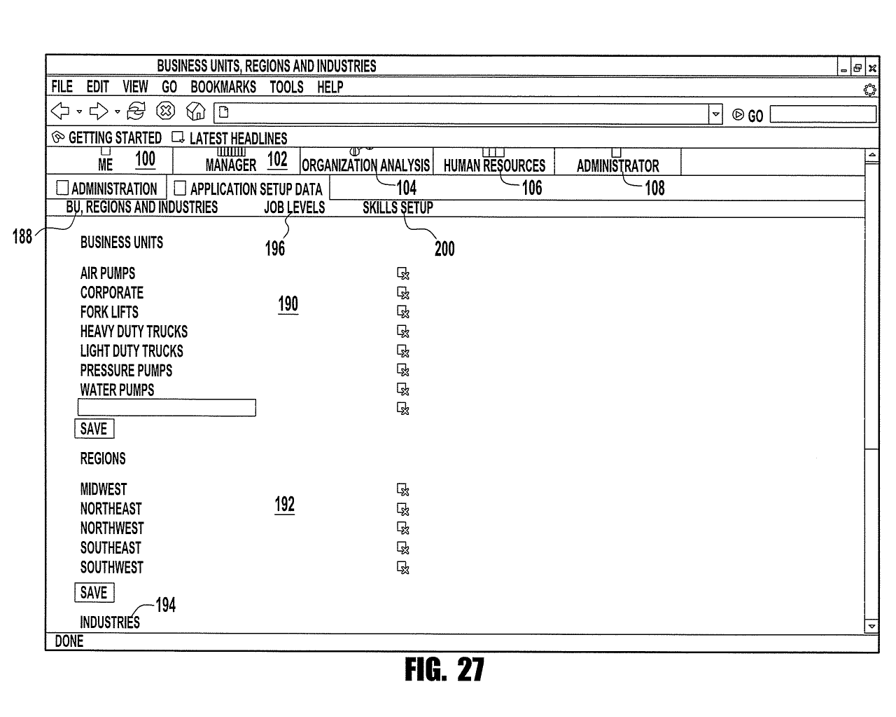

FIG. 25 illustrates a screenshot that results when the user selects an “Employee Performance Summary” tab 180. A review summary 182 for a selected employee (in this case Brittany S. Smithers) is displayed. FIG. 26 illustrates a screenshot that results when the user selects an “Employee Profile” tab 184. A profile 186 is displayed for the selected employee (in this case Brittany S. Smithers).

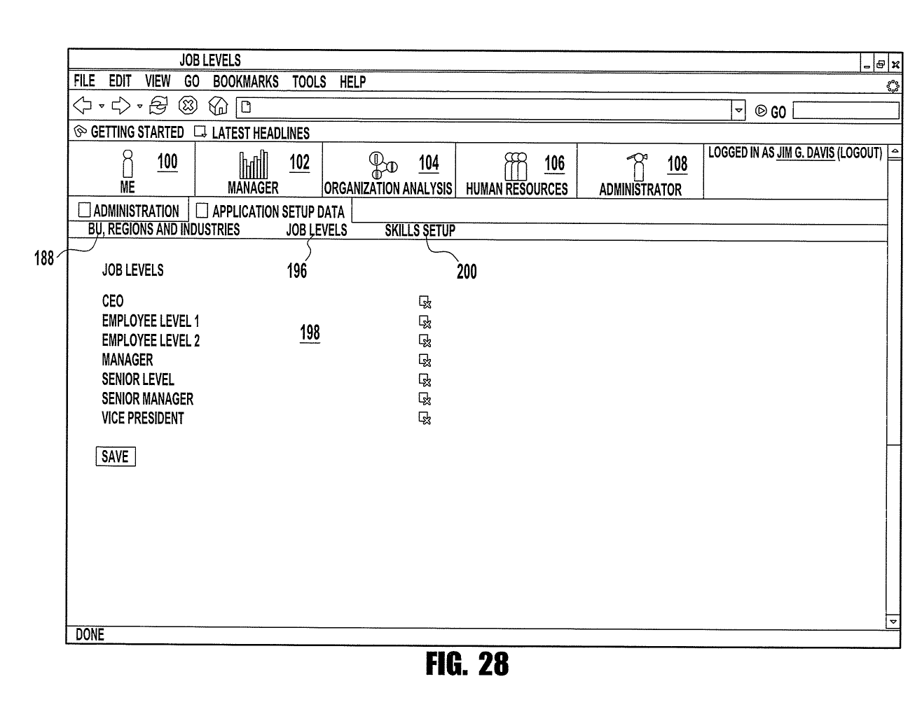

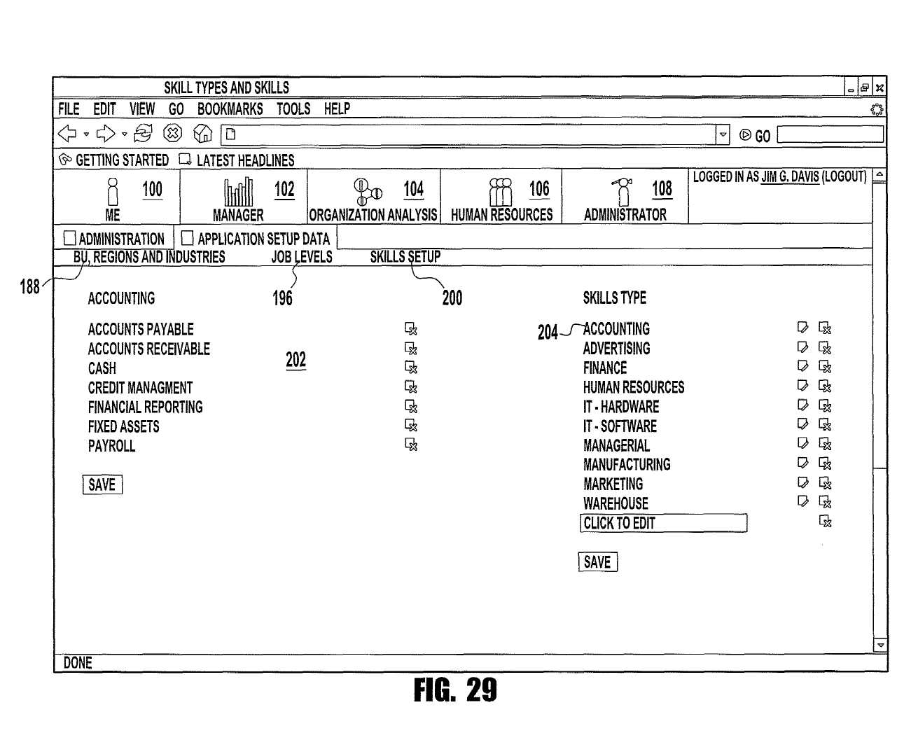

FIG. 27 illustrates a screenshot that results when the user selects a “BU, Regions and Industries” tab 188 under the administrator tab 108 when the user is acting as an administrator 22. Business units 190, regions 192 and industries 194 that are served by the system 10 are displayed. FIG. 28 illustrates a screenshot that results when the user selects a “Job Levels” tab 196 to display job levels 198 that are available in the organization that utilizes the system 10. FIG. 29 illustrates a screenshot that results when the user selects a “Skills Setup” tab 200 to display skills 202 that result when a skill type is selected at 204 (in this case skill type “Accounting”).

Various embodiments of the present invention may be implemented on computer-readable media. The terms “computer-readable medium” and “computer-readable media” in the plural as used herein may include, for example, magnetic and optical memory devices such as diskettes, compact discs of both read-only and writeable varieties, optical disk drives, hard disk drives, etc. A computer-readable medium may also include memory storage that can be physical, virtual, permanent, temporary, semi-permanent and/or semi-temporary. A computer-readable medium may further include one or more data signals transmitted on one or more carrier waves.

While the foregoing has been set forth in considerable detail, it is to be understood that the drawings and detailed embodiments are presented for elucidation and not limitation. Design variations may be made but are within the principles of the invention. Those skilled in the art will realize that such changes or modifications of the invention or combinations of elements, variations, equivalents, or improvements therein are still within the scope of the invention as defined in the appended claims.

What is claimed is:

1. A performance evaluation system, comprising:
a performance evaluation module configured to enable employee performance reviews based on completion of a plurality of tasks and a plurality of skills required to complete the tasks for each of a plurality of projects on which an employee is staffed, wherein the performance evaluation module returns an employee performance score for the employee in relation to other employees at comparable job levels as the employee;
a project staffing module configured to enable a user to staff a project by selecting at least one candidate employee based on a skill level proficiency rating in a desired skill and a length of time for which the candidate employee has utilized the desired skill;
a skills management module configured to enable a user to search a database for persons who have a specified skill; and
an external contacts module configured to enable a user to search for contact information in the database.

2. The system of claim 1, further comprising an enterprise resource planning system.

3. A computer-assisted method of evaluating a performance of a person, the method comprising:
presenting a survey to a plurality of employees associated with a unit, wherein the survey includes questions relating to a plurality of skills related to a project being performed by the unit;
calculating a first score of the performance of the person based on a plurality of answers given by the plurality of employees to the questions;
reviewing, by a supervisor, the person; and
calculating a final score of the performance of the person based on the first score of the performance of the person and the reviewing, by the supervisor, the person.

4. The method of claim 3, further comprising identifying, by the supervisor, the plurality of skills.

5. The method of claim 3, wherein the survey includes questions relating to a plurality of skills related to a project being performed by the unit and a plurality of skills related to a plurality of tasks of the unit.

6. The method of claim 3, wherein each of the plurality of skills has one of the questions associated therewith.

7. The method of claim 3, wherein calculating a first score includes calculating a centrality measure of importance relative to the plurality of employees associated with the unit.

8. The method of claim 3, further comprising reviewing, by the person, the person against each of a plurality of performance objectives specified by the supervisor during the supervisor review of the person.

9. The method of claim 3, further comprising staffing, by the supervisor, a project.

10. The method of claim 9, wherein staffing, by the supervisor, a project includes:
specifying, by the supervisor, at least one skill required to complete the project;
searching, by the supervisor, for at least one of the employees that has at least one of a high level of proficiency in the at least one of the plurality of skills and a long time period for which the at least one of the plurality of skills has been utilized; and
displaying a list of the employees that results from the searching.

11. The method of claim 3, further comprising managing, by the person, at least one of the plurality of skills.

12. The method of claim 11, wherein managing, by the person, at least one of the plurality of skills includes:
searching, by the person, for at least one of the employees that has at least one of a high level of proficiency in the at least one of the plurality of skills and a long time period for which the at least one of the plurality of skills has been utilized; and
displaying a list, to the person, of the results of the searching, wherein the list illustrates a social network relating to the at least one of the employees.

13. A system, comprising:
means for presenting a survey to a plurality of employees associated with a unit, wherein the survey includes questions relating to a plurality of skills related to a project being performed by the unit;
means for calculating a first score of a performance of a person based on a plurality of answers given by the plurality of employees to the questions;
means for reviewing, by a supervisor, the person; and
means for calculating a final score of the performance of the person based on the first score of the performance of the person and the reviewing, by the supervisor, the person.

14. A computer-readable medium having stored thereon instructions which, when executed by a processor, cause the processor to:
present a survey to a plurality of employees associated with a unit, wherein the survey includes questions relating to a plurality of skills related to a project being performed by the unit;
calculate a first score of a performance of a person based on a plurality of answers given by the plurality of employees to the questions;
enable review, by a supervisor, the person; and
calculate a final score of the performance of the person based on the first score of the performance of the person and the reviewing, by the supervisor, the person.
